(19) United States
(12) Patent Application Publication
(10) Pub. No.: US 2002/0140128 A1
(43) Pub. Date: Oct. 3, 2002

(54) Method of manufacturing a two component molded skin, shell, or body of a moldable material such as plastic by means of a "double slush" process

(76) Inventor: Petr Wolfgram, (US)

Correspondence Address: Welsh &Katz, Ltd., Jeffrey W. Salmon, Esq., 22nd Floor, 120 South Riverside Plaza, Chicago, IL, 60606, US

(21) Appl. No.: 09/823,113

(22) Filed: Mar. 30, 2001

(51) Int. Cl. B29C 41/22; B29C 71/00; B29C 71/02

(52) U.S. Cl. 264/236; 264/237; 264/255; 264/310

(57) ABSTRACT

A method of manufacturing a two-component skin by a “double slush” molding process is disclosed. In accordance with one aspect of the “double slush” molding process, after a first generally uniform layer of a moldable material that is at least partially cured is formed on a contoured surface of a mold, an additional amount of a moldable material is injected onto the at least partially cured first layer. Then, the mold is shaken to cause the additional moldable material to be generally evenly distributed on the first layer and form a second layer on top of the first layer. The mold also is heated to cure both the first and second layers and bond them together to form a two-component skin, shell, or body.

### FIELD OF THE INVENTION

The present invention generally relates to a method for producing a molded skin, shell, or body from a moldable material such as plastic and, more particularly, to a method for manufacturing a two-component molded skin, shell, or body from a moldable material such as plastic by means of a “double slush” molding process.

### BACKGROUND OF THE INVENTION

U.S. Pat. No. 5,221,539 (the “'539 patent”) discloses an apparatus for the production of molded skins and bodies of plastic material. The content of the '539 patent is incorporated by reference into this application as if it is fully disclosed herein. As background, a brief discussion of various statements in the '539 patent follows.

The '539 patent discloses a method for producing molded skins or shells by what is called a “rotational molding” technique. In accordance with this technique, a molded skin or shell is produced galvanically by depositing a moldable material, such as a liquid plastic material, in a mold. By heating the surface of the mold, a thin layer of plastic material adheres to the surface of the mold. The remaining plastic material can be shaken out or poured out by rotating the mold. After this, the skin or shell that clings to the mold is cured by, for example, further heating of the mold. The cured skin or shell is then removed from the mold after it has cooled down.

The '539 patent teaches an apparatus that allows the entire surface of the mold to be generally uniformly heating and cooled during a molding process. The heat exchanging structure disclosed in the '539 patent does not cause additional loading or deformation of the mold that would result in the production of unsatisfactory molded skins or shells, as stated in the '539 patent.

The apparatus disclosed in the '539 patent can be used to form a two-component molded skin by a slush molding process. In accordance with this process, a predetermined amount of a moldable material, such as liquid polyvinyl chloride (“PVC”), is injected onto a skin defining cavity of a mold. The mold is then “shaked” to cause the moldable material to be evenly distributed on the skin defining cavity, and is heated to cure the skin. After this, the skin is peeled off of the skin defining cavity, placed in another mold, and then a secondary slush molding process occurs to create a two-component molded skin.

The apparatus and methods disclosed in the '539 patent are suitable for their intended uses. However, manufacturing two-component molded skins, bodies, or shells in accordance with the techniques associated with the '539 patent are not desirable for a number of different reasons.

### BRIEF SUMMARY OF THE INVENTION

It is desirable to provide a method of manufacturing a two-component skin by a “double slush” molding process. In accordance with one aspect of the “double slush” molding process, after a first generally uniform layer of a moldable material that is at least partially cured is formed on a contoured surface of a mold, an additional amount of a moldable material is injected onto the at least partially cured first layer. Then, the mold is shaken to cause the additional moldable material to be generally evenly distributed on the first layer and form a second layer on top of the first layer. The mold also is heated to cure both the first and second layers and bond them together to form a two-component skin, shell, or body.

Providing such a “double slush” method has a number of distinct advantages. First, the “double slush” manufacturing process disclosed herein is suitable for a myriad of commercial scale applications in which large numbers of two-component skins, bodies, or shells may be formed at reduced cost over prior techniques of forming two-component skins. Second, use of the “double slush” method disclosed herein allows two-component skins to be formed with significantly reduced density over prior techniques. In automotive applications, this allows vehicles to have lower weight and, therefore, increased fuel efficiency. Third, the “double slush” molding techniques disclosed herein allow two-component molded skins to be formed that are useable in lower temperature environments without breaking.

Other features and advantages of the invention will become apparent from the description that follows.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is a schematic diagram of a “double slush” molding apparatus by which a two-component molded skins, shells, or bodies are manufactured;

FIG. 2 is a schematic, cross-sectional view of the mold shown in FIG. 1; and

FIG. 3 is a side view of a portion of a two-component molded skin that is formed utilizing the “double slush” molding apparatus illustrated in FIG. 1.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description Of The Invention”) relates to a requirement of the United States Patent Office, and should not be found to be limiting to the subject matter disclosed and claimed herein.

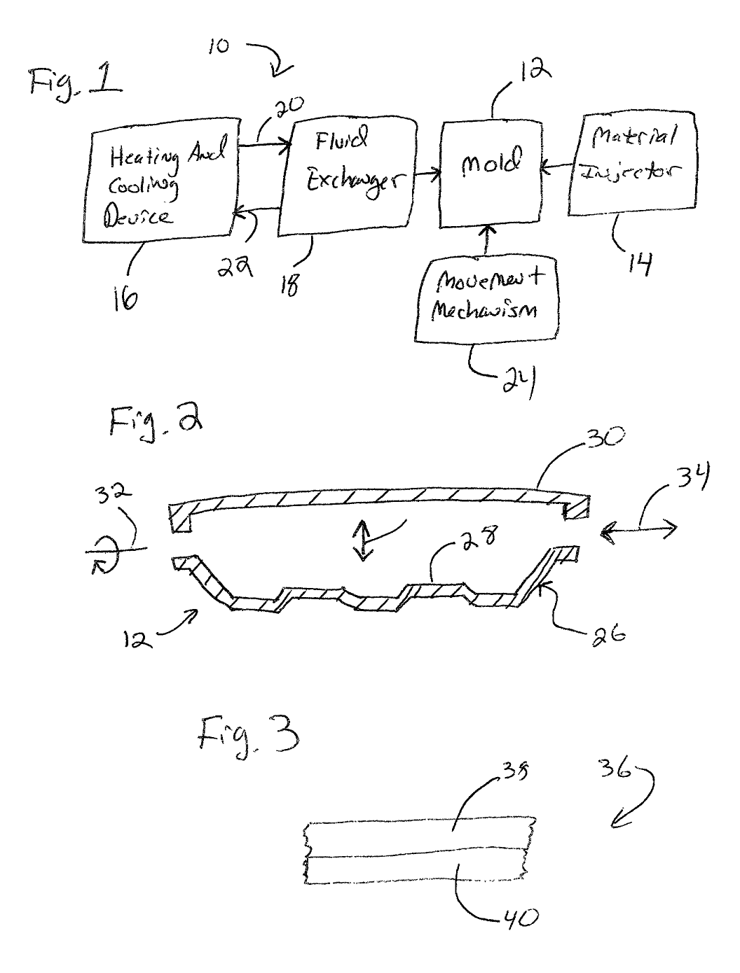

Referring to FIG. 1, a schematic diagram of a double slush molding apparatus 10 by which a two-component molded skins, shells, or bodies are manufactured is shown. Double slush molding apparatus 10 includes a mold 12 that includes a contoured surface (not shown) on which a molded skin, body, shell or the like is formed from a predetermined amount of a moldable material that is injected onto the mold 12 via material injector 14.

A heating and cooling device 16 is operatively coupled to a fluid exchanger 18 via input conduit 20 and an output conduit 22. Heating and cooling device 16 is adapted to supply either a heated fluid or a cooling fluid at controlled temperatures to the fluid exchanger 18 in a controlled fashion in accordance with predetermined parameters. The fluid exchanger 18 is operatively coupled to the mold 12 so that the mold 12 either can be rapidly heated or rapidly cooled in accordance with the heated or cooled fluid that is supplied to fluid exchanger 18 by the heating and cooling device 16 as desired. A fluid exchanger suitable for use in connection with the present invention is disclosed, for example, in the '539 patent.

A movement mechanism 24 is operatively coupled to the mold 12. Referring to FIG. 2, mold 12 includes a first mold half 26 that has a contoured inner surface 28. Mold 12 also includes an upper mold half 30. Mold halves 26 and 30 are moveable with respect to each other from an open position to a closed position. In the open position, molded skins, shells, bodies or the like that are formed in mold 12 can be removed therefrom. In the open position, material injector 14 (FIG. 1) is adapted to inject a predetermined quantity of a moldable material such as, for example, liquid PVC onto the contoured surface 28 of lower mold half 26.

In the closed position of the mold 12, upper and lower mold halves 30 and 26 are operatively joined together to allow the movement mechanism to be moved in an empirically determined fashion to cause the moldable material to be evenly distributed on the contoured surface 28 of the lower mold half 26. For example, referring to FIG. 2, movement mechanism 24 causes the mold 12 to be rotated about the axis 32 and moved in a reciprocating fashion along the line 34 in a predetermined sequence. During this process, the heating and cooling device 16 and the fluid exchanger 18 cooperate to heat the lower mold half to cause a molded skin to be formed on the contoured surface 28.

In accordance with an exemplary aspect of the present invention disclosed herein, a two-component molded skin, body, shell or the like is formed by a “double slush” molding process. In accordance with this process, a predetermined quantity of moldable material is injected onto the contoured surface 28 as it is being heated and moved in an empirically determined sequence that generally corresponds to the shape and intricacies of the contoured surface 28. The heat applied to the contoured surface 28 causes a relatively thin first skin to be formed thereon.

After the first skin has at least been partially cured, the mold halves 26 and 30 are opened to allow the material injector 14 to inject a second predetermined amount of a second moldable material, such as, for example, a foam backing material, onto the at least partially cured first skin. Then, the mold 12 is again moved in an empirically determined sequence to ensure that the second moldable material is generally evenly distributed on top of the first skin to create a second skin that is at least partially formed and bonded to the first skin as discussed in greater detail hereafter.

The heating and cooling device 16 and fluid exchanger 18 cooperate to heat the lower mold half 26 to a sufficient temperature to cure the first and second skins and fully bond them together to form a two-component skin. After the first and second skins have been cured and bonded together, the second mold half 26 is cooled by means of device 16 and exchanger 18, the mold 12 is opened, and the two-component skin is then removed from the mold.

Referring to FIG. 3, a partial side view of an exemplary two-component skin 36 that is formed by the “double slush” molding process disclosed herein is illustrated. Two-component skin 36 includes first and second skins 38 and 40 that are cured and bonded together as discussed above. In an exemplary automotive application of the present invention, the two-component skin 36 comprises a dashboard cover that is fitted over a skeleton frame to define a portion of the interior of an automobile. In exemplary application, the two-component skin 36 is “double slushed” so that first skin 38 is formed from a liquid PVC compound that has an approximate thickness from 0.60-0.8 mm. The second skin 40 is formed from a foam material that has an approximate thickness of 0.6-0.8 mm.

One advantageous feature of the “double slush” molding process disclosed herein is that two-component skins can be made to be less dense and, therefore, lighter. In the above-referenced exemplary automotive application of the present invention, a two-component skin can be manufactured to have a density of approximately 0.8 kg/ltr, instead of a density of 1.25 kg/ltr as would be the case with known techniques for forming two-component skins. This allows, for example, the weight of a vehicle to be reduced and, therefore, the fuel efficiency of the vehicle to be increased.

A second advantageous feature of the present invention disclosed herein is that the “double slush” molded two-component skins have remarkable properties concerning their resistance to temperature. For example, in the exemplary automotive application discussed above, an automobile dashboard can be created that allows airbags to be deployed through the dashboard without a harmful level of fragmentation that would injure an automobile occupant down to temperatures of approximately −35° C.

From the foregoing, it will also be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims when the claims are properly interpreted.

What is claimed is:

1. A method of manufacturing a two-component skin, comprising the steps of:
injecting a predetermined amount of a first moldable material onto a contoured shape of a mold;
moving said mold to cause said first moldable material to be generally evenly distributed on said contoured shape of said mold while heating said mold to cause a generally uniform at least partially cured first skin to be formed on said contoured shape of said mold;
injecting a predetermined amount of a second moldable material onto said at least partially cured first skin; and
moving said mold to cause said second moldable material to be generally evenly distributed on said at least partially cured first skin while heating said mold to cause said a generally uniform second skin that is at least partially cured to be formed on said first skin.

2. The method of claim 1 further comprising the step of heating said first and second skins to cure said first and second skins, to bond said first and second skins together, thereby forming a two-component skin.

3. The method of claim 2 further comprising the step of cooling said mold.

4. The method of claim 2 further comprising the step of removing said two-component skin from said mold.

5. The method of claims 4 further comprising the step of forming said two-component skin into a desired shape.
